(19) United States
(12) Patent Application Publication
(10) Pub. No.: US 2021/0073728 A1
(43) Pub. Date: Mar. 11, 2021

(54) APPARATUS, METHODS, AND STORAGE MEDIA FOR RECOMMENDING PICK-UP LOCATIONS

(71) Applicant: BEIJING DIDI INFINITY TECHNOLOGY AND DEVELOPMENT CO., LTD., Beijing (CN)

(72) Inventors: Peng YU, Beijing (CN); Muliang LUO, Beijing (CN); Kai YAN, Beijing (CN); Huan CHEN, Beijing (CN)

(73) Assignee: BEIJING DIDI INFINITY TECHNOLOGY AND DEVELOPMENT CO., LTD., Beijing (CN)

(21) Appl. No.: 17/080,861

(22) Filed: Oct. 27, 2020

Related U.S. Application Data
(63) Continuation of application No. PCT/CN2019/084800, filed on Apr. 28, 2019.

(30) Foreign Application Priority Data
Jun. 11, 2018 (CN) 201810595955.4

(51) Int. Cl. G06Q 10/08; G01C 21/36; G01C 21/20; G01C 21/34

(52) U.S. Cl. CPC G06Q 10/0833; G06Q 10/0836; G01C 21/3476; G01C 21/20; G01C 21/3605

(57) ABSTRACT

The present disclosure discloses an apparatus, a method, and a storage medium for recommending a pick-up location. Departure location information of a first user may be acquired, where the departure location information of the first user includes at least one of a name of a departure location or positioning information of the departure location. One or more recommended pick-up locations associated with the departure location information determined based at least on the departure location information may be received. And the one or more recommended pick-up locations may be displayed with markings.

### CROSS-REFERENCE TO RELATED APPLICATIONS

This application is a continuation of International Application No. PCT/CN2019/084800 filed on Apr. 28, 2019, which priority to Chinese Patent Application No. 201810595955.4 filed on Jun. 11, 2018, the contents of which are incorporated herein by reference in their entirety.

### TECHNICAL FIELD

The present disclosure generally relates to Internet applications, and more particularly, relates to apparatus, methods, and storage media for recommending pick-up locations in an on-line service.

### BACKGROUND

With the rapid development of mobile communication technology, a large number of applications based on smart devices used in daily life have emerged in recent years, with car-hailing applications as some of the most popular ones. Passengers can enter start location information and destination information through a client device, and send service requests including the start location information and destination information to service providers (e.g., drivers). Drivers who accept the service requests can pick up the passengers according to the start location information. However, in real-life scenarios, the start location that the passengers enter may not be convenient for either parties. If the locations as entered by the passengers are used as pick-up locations, drivers often encounter difficulties. Therefore, it is desirable to provide systems and methods that facilitate finding suitable pick-up locations.

### SUMMARY

According to an aspect of the present disclosure, an apparatus for recommending a pick-up location may be provided. The apparatus may comprise at least one storage medium including a set of instructions that recommend a pick-up location and at least one processor configured to communicate with the at least one storage medium. When executing the set of instructions, the at least one processor is directed to obtain departure location information of a first user, where the departure location information of the first user includes at least one of a name of a departure location or positioning information of the departure location; receive one or more recommended pick-up locations associated with the departure location information based at least on the departure location information; and display the one or more recommended pick-up locations with markings.

In some embodiments, to receive one or more recommended pick-up locations associated with the departure location information based at least on the departure location information, the at least one processor is directed to send the departure location information to a server, and receive the one or more recommended pick-up locations determined by the server based on the departure location information.

In some embodiments, to receive the one or more recommended pick-up locations determined by the server based on the departure location information, the at least one processor is directed to receive information for displaying one or more pick-up locations related to the departure location information from the server, wherein the one or more pick-up locations include the one or more recommended pick-up locations.

In some embodiments, the markings include text markings and to display the one or more recommended pick-up locations with the markings, the at least one processor is directed to place the text markings next to the one or more recommended pick-up locations.

In some embodiments, to display the one or more pick-up locations, the at least one processor is directed to display the one or more pick-up locations in a list, wherein the one or more recommended pick-up locations are displayed on top of the list.

In some embodiments, at least one of the recommended pick-up locations is associated with a pick-up location in a history order of the first user.

In some embodiments, to obtain the departure location information of the first user, the at least one processor is directed to obtain textual information of the departure location input by the first user.

In some embodiments, the processor is further directed to obtain a pick-up location selected by the first user, and send the selected pick-up location to a user terminal of a second user.

In some embodiments, the processor is further directed to determine a pedestrian navigation path according to a current location of the first user and the selected pick-up location, and display the pedestrian navigation path on a user terminal of the first user.

In some embodiments, the processor is further configured to determine an estimated walking duration of the first user according to a current location of the first user and the selected pick-up location.

In some embodiments, the processor is further directed to determine an estimated pick-up duration of the second user according to a current location of the second user and the selected pick-up location.

In some embodiments, the processor is further directed to compare an estimated walking duration of the first user with the estimated pick-up duration of the second user, and send a reminder to the first user if the estimated walking duration of the first user is greater than or equal to the estimated pick-up duration of the second user.

In some embodiments, the processor is further directed to obtain at least one candidate point of interest (POI) related to the departure location information, each POI having a corresponding selection probability, determine the one or more pick-up locations related to the departure location information according to the at least one candidate POI, determine at least one target POI in the at least one candidate POI with a selection probability higher than a threshold; and determine the one or more recommended pick-up locations according to the at least one target POI.

According to another aspect of the present disclosure, a method implemented on a computing device having at least one processor and at least one computer-readable storage medium for recommending a pick-up location may be provided. The method may comprise obtaining departure location information of a first user, where the departure location information of the first user includes at least one of a name of a departure location or positioning information of the departure location; receiving one or more recommended pick-up locations associated with the departure location information based at least on the departure location information; and displaying the one or more recommended pick-up locations with markings.

According to still another aspect of the present disclosure, a system for recommending a pick-up location may be provide. The system may comprise an acquiring module configured to obtain departure location information of a first user, where the departure location information of the first user includes at least one of a name of a departure location or positioning information of the departure location; a receiving module configured to receive one or more recommended pick-up locations associated with the departure location information based at least on the departure location information; and a displaying module configured to display the one or more recommended pick-up locations with markings.

According to a further aspect of the present disclosure, a computer readable storage medium storing computer instructions may be provided. When the computer instructions are executed by at least one processor, cause the system to execute a method, the method comprising obtaining departure location information of a first user, where the departure location information of the first user includes at least one of a name of a departure location or positioning information of the departure location; receiving one or more recommended pick-up locations associated with the departure location information based at least on the departure location information; and displaying the one or more recommended pick-up locations with markings.

According to a further aspect of the present disclosure, an apparatus for recommending a pick-up location may be provided. The apparatus may comprise at least one storage medium including a set of instructions that recommend a pick-up location and at least one processor configured to communicate with the at least one storage medium, wherein when executing the set of instructions, the at least one processor is directed to obtain departure location information of a first user, where the departure location information of the first user includes at least one of a name of a departure location or positioning information of the departure location; determine one or more recommended pick-up locations associated with the departure location information based at least on the departure location information; and send the one or more recommended pick-up locations related to the departure location information to a user terminal of the first user.

In some embodiments, to determine one or more recommended pick-up locations associated with the departure location information based at least on the departure location information, the at least one processor is directed to determine one or more pick-up locations related to the departure location information based at least on the departure location information; and determine the one or more recommended pick-up locations related to the departure location information based on the one or more pick-up locations.

In some embodiments, the at least one processor is further directed to determine markings for facilitating selection of the one or more recommended pick-up locations related to the departure location information, and send the markings with the one or more recommended pick-up locations to the user terminal of the first user.

In some embodiments, the markings comprise a text marking for each recommended pick-up location.

In some embodiments, the at least one processor is further directed to obtain at least one candidate point of interest (POI) related to the departure location information, each POI having a corresponding selection probability, determine the one or more pick-up locations related to the departure location information according to the at least one candidate POI, determine at least one target POI in the at least one candidate POI with a selection probability higher than a threshold, and determine the one or more recommended pick-up locations according to the at least one target POI.

In some embodiments, to determine the at least one target POI in the at least one candidate POI with a selection probability higher than a threshold, the at least one processor is directed to determine top N candidate POIs with higher selection probability in the at least one candidate POI, where N is an integer greater than or equal to 1, designate candidate POIs of the top N candidate POIs with selection probabilities greater than the threshold as the at least one target POI.

In some embodiments, the processor is further directed to determine the one or more recommended pick-up locations according to pick-up locations in history orders of the first user.

In some embodiments, the processor is further directed to obtain a pick-up location selected by the first user, send the selected pick-up location to a user terminal of a second user.

In some embodiments, the processor is further configured to determine a pedestrian navigation path according to a current location of the first user and the selected pick-up location, and display the pedestrian navigation path on a user terminal of the first user.

In some embodiments, the processor is further directed to determine an estimated walking duration of the first user according to a current location of the first user and the selected pick-up location.

In some embodiments, the processor further directed to determine an estimated pick-up duration of the second user according to a current location of the second user and the selected pick-up location.

In some embodiments, the processor is further directed to compare an estimated walking duration of the first user with the estimated pick-up duration of the second user, and send a reminder to the first user if the estimated walking duration of the first user is greater than or equal to the estimated pick-up duration of the second user.

According to a further aspect of the present disclosure, a method implemented on a computing device having at least one processor and at least one computer-readable storage medium for recommending a pick-up location may be provided. The method may comprise obtaining departure location information of a first user, where the departure location information of the first user includes at least one of a name of a departure location or positioning information of the departure location; determining one or more recommended pick-up locations associated with the departure location information based at least on the departure location information; and sending the one or more recommended pick-up locations related to the departure location information to a user terminal of the first user.

According to a further aspect of the present disclosure, a system for recommending a pick-up location may be provided. The system may include an acquiring module configured to obtain departure location information of a first user, where the departure location information of the first user includes at least one of a name of a departure location or positioning information of the departure location; a determination module configured to determine one or more recommended pick-up locations associated with the departure location information based at least on the departure location information; a transmitting module configured to send the one or more recommended pick-up locations related to the departure location information to a user terminal of the first user.

According to still a further aspect of the present disclosure, a computer readable storage medium storing computer instructions may be provided. When the computer instructions are executed by at least one processor, cause the system to execute a method, the method comprising obtaining departure location information of a first user, where the departure location information of the first user includes at least one of a name of a departure location or positioning information of the departure location; determining one or more recommended pick-up locations associated with the departure location information based at least on the departure location information; and sending the one or more recommended pick-up locations related to the departure location information to a user terminal of the first user.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram of an application scenario of a pick-up location recommendation system according to some embodiments of the present disclosure;

FIG. 2 is a block diagram of an exemplary computing device 200 according to some embodiments of the present disclosure;

FIG. 3 is a block diagram illustrating exemplary hardware and/or software components of an exemplary mobile device according to some embodiments of the present disclosure;

FIG. 4 is a flow chart illustrating an exemplary process for recommending a pick-up location according to some embodiments of the present disclosure;

FIG. 5 is a block diagram illustrating a pick-up location recommending apparatus according to some embodiments of the present disclosure;

FIG. 6 is a schematic diagram of a display interface for recommending a pick-up location according to some embodiments of the present disclosure;

FIG. 7 is a flow chart of an exemplary process for recommending a pick-up location according to some embodiments of the present disclosure;

FIG. 8 is a block diagram of an exemplary pick-up location recommendation apparatus according to some embodiments of the present disclosure; and

FIG. 9 is a flow chart of an exemplary process for determining one or more recommended pick-up locations according to some embodiments of the present disclosure.

### DETAILED DESCRIPTION

In order to illustrate the technical solutions related to the embodiments of the present disclosure, brief introduction of the drawings referred to in the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

As used in the disclosure and the appended claims, the singular forms “a,” “an,” and “the” include plural referents unless the content clearly dictates otherwise. It will be further understood that the terms “comprises,” “comprising,” “includes,” and/or “including” when used in the disclosure, specify the presence of stated steps and elements, but do not preclude the presence or addition of one or more other steps and elements.

Some modules of the system may be referred to in various ways according to some embodiments of the present disclosure, however, any number of different modules may be used and operated in a client terminal and/or a server. These modules are intended to be illustrative, not intended to limit the scope of the present disclosure. Different modules may be used in different aspects of the system and method.

According to some embodiments of the present disclosure, flow charts are used to illustrate the operations performed by the system. It is to be expressly understood, the operations above or below may or may not be implemented in order. Conversely, the operations may be performed in inverted order, or simultaneously. Besides, one or more other operations may be added to the flowcharts, or one or more operations may be omitted from the flowchart.

Technical solutions of the embodiments of the present disclosure be described with reference to the drawings as described below. It is obvious that the described embodiments are not exhaustive and are not limiting. Other embodiments obtained, based on the embodiments set forth in the present disclosure, by those with ordinary skill in the art without any creative works are within the scope of the present disclosure.

Some embodiments of the present disclosure are directed to an on-line service prediction function applicable in, e.g., on-demand services, which is a newly emerged service or demand rooted only in the post-Internet era. It provides the technical solutions to customers that could rise only in the post-Internet era. In the pre-Internet era, it is impossible to predict types of services requested by users. Therefore, the present solution is deeply rooted in and aimed to solve a problem only occurred in the post-Internet era.

Embodiments of the present disclosure may be applied to different transport service systems including, but not limited to, terrestrial, water surface navigation, aerospace, or the like, or any combination thereof. For example, transportation tools used in the transport service system may include one of a rickshaw, bicycle, motor bike, vehicles (e.g., small cars, buses, large transport vehicles, etc.), rail transit (e.g., trains, high-speed rail, subways, etc.), ships, planes, spaceships, satellites, hot air balloons, unmanned vehicles, or the like, or any combination thereof. The different embodiments of the present application scenarios may include, but are not limited to, transportation industry, warehouse logistics industry, agricultural system, city bus system, commercial vehicle, or the like, or any combination thereof. It should be understood that the systems and methods of the present disclosure are merely some examples or embodiments of the present disclosure. For those skilled in the art, the present application may be applied to other similar scenarios according to these drawings without any creative work. For example, other similar scenarios may be driving systems with trajectory.

In some embodiments, various transport service systems may be provided with recommended pick-up locations. The recommended pick-up locations may be displayed to a user of a transport service and/or a provider of a transport service, such that the user and the provider may be aware of the pick-up location, thus benefiting the user and the provider in the transport service.

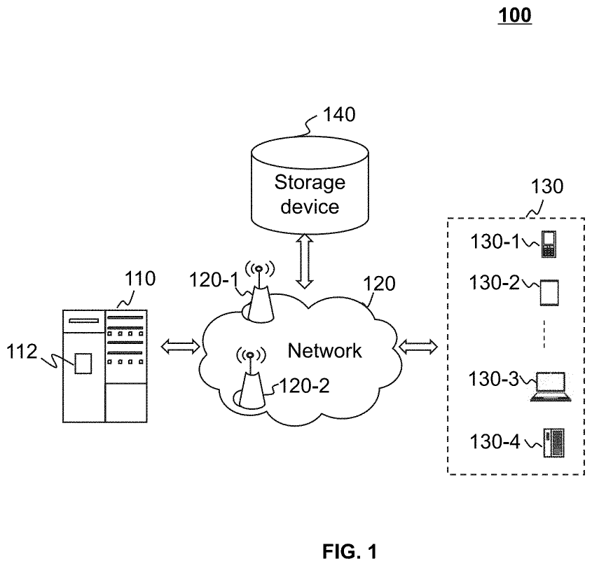

FIG. 1 is a schematic diagram of an application scenario of a pick-up location recommendation system according to some embodiments of the present disclosure. The pick-up location recommendation system 100 may recommend pick-up locations to a passenger and guide the passenger to select an appropriate pick-up location. The pick-up location recommendation system 100 may be an online service platform for Internet services. For example, the pick-up location recommendation system 100 may be an online transportation service platform for transportation services. In some embodiments, the pick-up location recommendation system 100 may be used for online car services, such as taxi services, express services, private car services, minibus services, carpooling services, bus services, driver hire services, and/or pick-up services.

In some embodiments, the pick-up location recommendation system 100 may also be applied to designated driver services. In some embodiments, the pick-up location recommendation system 100 may also be applied to game services, travel services, education (e.g., online education) services, or the like. The pick-up location recommendation system 100 may be an online service platform, including a server 110, a network 120, a user terminal 130, and a storage device 140. The server 110 may include a processing device 112.

In some embodiments, the processing device 112 may match pick-up locations for a user according to the user's departure location, and select one or more of the pick-up locations as recommended pick-up locations sent to the user.

In some embodiments, the server 110 may be used to process information and/or data related to a pick-up location recommendation. The server 110 may be a single server, or a server group. The server group may be a centralized server group connected to the network 120 via an access point, or a distributed server group connected to the network 120 via one or more access points, respectively. In some embodiments, the server 110 may be locally connected to the network 120 or in remote connection with the network 120. For example, the server 110 may access the information and/or data stored in the user terminal 130, the storage device 140 through the network 120. In some embodiments, the server 110 may directly connect with the user terminal 130, the storage device 140 to access the information and/or data stored therein. In some embodiments, the server 110 may be implemented on a cloud platform. For example, the cloud platform may include one of a private cloud, a public cloud, a hybrid cloud, a social area cloud, a distributed cloud, an internal cloud, or the like, or any combination thereof. In some embodiments, the server 110 or the cloud platform may store a correspondence relationship between start locations and recommended pick-up locations. When the server receives a start location information, it may quickly obtain one or more recommended pick-up locations according to the correspondence relationship. A pick-up location recommendation model may be trained on the server or the cloud platform, and one or more recommended pick-up locations may be provided to a user according to the model.

The processing device 112 may process data and/or information related to the service request to perform one or more of the functions described in this disclosure. For example, the processing device 112 may receive a service request signal sent by the user terminal 130 to provide one or more recommended pick-up locations to the user. In some embodiments, the processing device 112 may include one or more sub-processing devices (e.g., a single-core processing device or a multi-core processing device). For example only, the processing device 112 may include one of a central processor (CPU), an application specific integrated circuit (ASIC), a dedicated instruction processor (ASIP), a graphics processor (GPU), a physical processor (PPU), a digital signal processor (DSP), a field programmable gate array (FPGA), an editable logic circuit (PLD), a controller, a microcontroller unit, a reduced instruction set computer (RISC), a microprocessor, or the like, or any combination thereof.

In some embodiments, a complete process for pushing a location recommendation may be executed by one processor or by two processors. For example, one of the processors may obtain all possible pick-up locations according to departure location information input by the user, and another processor may select one or more recommended pick-up locations from all possible pick-up locations.

Network 120 may facilitate the exchange of data and/or information. In some embodiments, the one or more component (e.g., the server 110, the user terminal 130, the storage device 140) of the pick-up location recommendation system 100 may send pick-up locations to other components in the system 100 via the network 120 send data and/or information. In some embodiments, the network 120 may be any type of wired or wireless network. For example, the network 120 may include a cable network, a wired network, a fiber optic network, a telecommunications network, an internal network, an internet network, a regional network (LAN), a wide area network (WAN), a wireless region network (WLAN), a metropolitan area network (MAN), a public switched telephone network (PSTN), a Bluetooth network, a ZigBee network, a near field communication (NFC) network, etc., or any combination thereof. In some embodiments, the network 120 may include one or more network access points. For example, network 120 may include wired or wireless network access points such as base station and/or internet exchange points 120-1, 120-2 . . . , through these access points, the one or more component of the pick-up location recommendation system 100 may be connected to the network 120 to exchange data and/or information.

For example, information about recommended pick-up location obtained by the processing device 112 may be transmitted to the user terminal 130 through the network 120. As another example, one or more recommended pick-up locations, which may be related to the departure location information input by a user, determined by the processing device 112 may be transmitted to the storage device 140 for storage through the network 120.

In some embodiments, the user may obtain one or more recommended pick-up locations through the user terminal 130. In some embodiments, the user terminal 130 may include one of a mobile device 130-1, a tablet computer 130-2, a laptop 130-3, a vehicle built-in device 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass™, an Oculus Rift™, a Hololens™, a Gear VR™, etc. In some embodiments, a built-in device in the vehicle 130-4 may include a built-in computer, an onboard built-in television, a built-in tablet, etc. In some embodiments, the user terminal 130 may include a positioning device for determining a location of a user and/or the user terminal 130.

In some embodiments, the user terminal 130 may be a passenger terminal (e.g., a first user terminal) or a driver terminal (e.g., a second user terminal). For example, a passenger may select a pick-up location from recommended pick-up locations obtained by the passenger terminal, which may be sent to the drivers terminal, then a driver may pick up the passenger according to the pick-up location selected by the passenger.

The storage device 140 may store data and/or instructions. In some embodiments, the storage device 140 may store data acquired from the user terminal 130. In some embodiments, the storage device 140 may store information and/or instructions that the server 110 may execute to perform the exemplary methods described in this disclosure. In some embodiments, the storage device 140 may include a large amount of memory, a removable memory, a volatile read/write memory (such as random access memory RAM), a read only memory (ROM), or the like, or any combination thereof. In some embodiments, the storage device 140 may be implemented on a cloud platform. For example, the cloud platform may include a private cloud, a public cloud, a hybrid cloud, a social area cloud, a distributed cloud, an internal cloud, or the like, or any combination thereof.

In some embodiments, correspondence relationships between departure location information input by a current user, corresponding recommended pick-up locations, and selected pick-up locations may be stored in the storage device 140 or other storage devices. For example, a storage device may store departure locations input by a current user, corresponding recommended pick-up locations, and selected pick-up locations may be stored in a cloud storage. In some embodiments, the storage device 140 may store order information of a current user, and provide one or more recommended pick-up locations corresponding to a departure location of the user based on the order information.

In some embodiments, the storage device 140 may be coupled to the network 120 to communicate with one or more components of the pick-up location recommendation system 100 (e.g., the server 110, the user terminal 130, etc.). The one or more component of the pick-up location recommendation system 100 may access data or instructions stored in the storage device 140 through the network 120. In some embodiments, the storage device 140 may directly connect or communicate with one or more component (e.g., the server 110, the user terminal 130) in the pick-up location recommendation system 100. In some embodiments, the storage device 140 may be part of the server 110.

In some embodiments, the one or more component of the pick-up location recommendation system 100 (e.g., the server 110, the user terminal 130, etc.) may have access to the storage device 140. In some embodiments, when one or more conditions are met, the one or more components of the pick-up location recommendation system 100 (e.g., the server 110, the user terminal 130, etc.) may read and/or modify the information associated with the user. For example, at an end of a car service, the server 110 may read and/or modify one or more user's information.

In some embodiments, information exchange among one or more components in the system 100 may be implemented by requesting a service. The requested service may be any product. In some embodiments, the product may be tangible or intangible. Tangible products may include food, pharmaceuticals, commodities, chemical products, appliances, clothes, cars, houses, luxury goods, or the like, or any combination thereof. Intangible products may include services, financial products, knowledge, internet product, or the like. For example, the product may be software and/or application programs used in a computer or mobile phone. The software and/or applications may be associated with social, shopping, transportation, entertainment, learning, investment, or the like, or any combination thereof.

In some embodiments, transportation-related software and/or applications may include travel software and/or application, vehicle scheduling software and/or application, map software and/or application. In the vehicle scheduling software and/or the application, transportation tools may include a carriage, rickshaws (e.g., bicycles, tricycles, etc.), vehicles (e.g., taxis, buses, cars, etc.), trains, subways, ships, an aircraft (e.g., an airplane, a helicopter), a space shuttle, a rocket, a hot air balloon, etc.

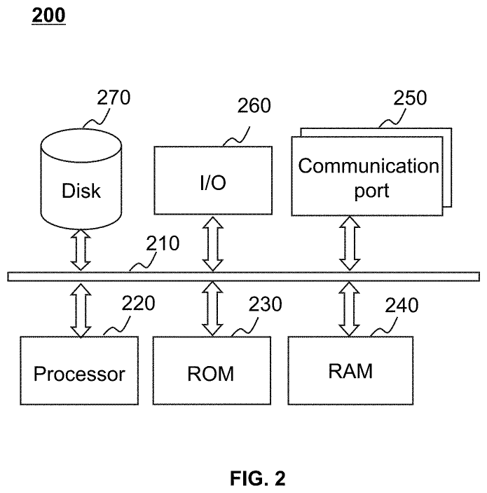

FIG. 2 is a block diagram of an exemplary computing device 200 according to some embodiments of the present disclosure.

As shown in FIG. 2, the computing device 200 may include a processor 210, a storage 220, an input/output interface 230, and a communication port 240. The processor 210 may execute computational instructions (program code) and perform the functions of the system 100 described in this disclosure. The computer instructions may include routines, programs, objects, components, data structures, procedures, modules, and functions, which perform particular functions described herein. For example, the processor 210 may process data obtained from any other component of the pick-up location recommendation system 100. In some embodiments, the processor 210 may include a microcontroller, a microprocessor, a reduced instruction set computer (RISC), an application specific integrated circuit (ASIC), an applications specific instruction set processor (ASIP), a central processor (CPU), a graphics processing unit (GPU), a physical processing unit (PPU), a microcontroller unit, a digital signal processor (DSP), a field programmable gate array (FPGA), an advanced RISC machine (ARM), a programmable logic device, and any circuitry and processor capable of performing one or more functions, or any combination thereof. For illustration purposes, the computing device 200 in FIG. 2 describes only one processor, however, it should be noted that the computing device 200 in the present disclosure may also include a plurality of processors.

The storage 220 may store data/information obtained from any other component of the pick-up location recommendation system 100. In some embodiments, the storage 220 may include a mass storage memory, a removable memory, a volatile read and a write memory, and a read only memory (ROM), or the like, or any combination thereof. An exemplary mass storage device may include a magnetic disk, a compact disk, and a solid state drive. The removable memory may include a flash drive, a floppy disk, an optical disk, a memory card, a compact disk, a tape, or the like. The volatile read and write memory may include a random access memory (RAM). The RAM may include a dynamic RAM (DRAM), a double rate synchronous dynamic RAM (DDR SDRAM), a static RAM (SRAM), a thyristor RAM (T-RAM), and a zero capacitance (Z-RAM). The ROM may include a mask ROM (MROM), a programmable ROM (PROM), an erasable programmable ROM (PEROM), an electrically erasable programmable ROM (EEPROM), a compact disc ROM (CD-ROM) and a digital versatile disc ROM.

The input/output interface 230 may be used to input or output signals, data, or information. In some embodiments, the input/output interface 230 may enable a user to interact with the pick-up location recommendation system 100. In some embodiments, the input/output interface 230 may include an input device and an output device. An exemplary input device may include a keyboard, a mouse, a touch screen, a microphone, or the like, or any combination thereof. An exemplary output device may include a display device, a speaker, a printer, a projector, or the like, or any combination thereof. Exemplary displays may include a liquid crystal display (LCD), a light emitting diode (LED) based display, a flat panel display, a curved display, a television device, a cathode ray tube (CRT), or the like, or any combination thereof.

The communication port 240 may be connected to a network for data communication. The connection may be a wired connection, a wireless connection, or a combination of both. The wired connection may comprise a cable, a fiber optic cable, a telephone line, or the like, or any combination thereof. The wireless connection may include Bluetooth, Wi-Fi, WiMax, WLAN, ZigBee, mobile network (e.g., 3G, 4G, 5G, etc.), or the like, or any combination thereof. In some embodiments, the communication port 240 may be a standardized port such as RS232, RS485, or the like. In some embodiments, the communication port 240 may be a specially designed port.

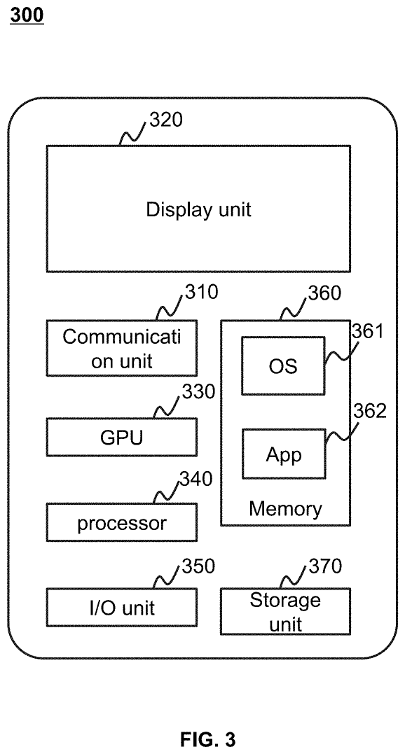

FIG. 3 is a block diagram illustrating exemplary hardware and/or software components of an exemplary mobile device according to some embodiments of the present disclosure. The user terminal 130 or the driver device 140 may be implemented on the mobile device 300 according to some embodiments of the present disclosure. As illustrated in FIG. 3, the mobile device 300 may include a communication module 310, a display 320, a graphic processing unit (GPU) 330, a central processing unit (CPU) 340, an I/O 350, a memory 360, and a storage 390. The CPU 340 may include interface circuits and processing circuits similar to the processor 220. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to a service request or other information from the transportation recommendation system on the mobile device 300. User interactions with the information stream may be achieved via the I/O devices 350 and provided to the processing device 112 and/or other components of the travel service recommendation system 100 via the network 150.

In order to implement various modules, units and their functions described above, a computer hardware platform may be used as hardware platforms of one or more elements (e.g., a component of the server 110 described in FIG. 1). Since these hardware elements, operating systems, and program languages are common, it may be assumed that persons skilled in the art may be familiar with these techniques and they may be able to provide information required in the data classification according to the techniques described in the present disclosure. A computer with a user interface may be used as a personal computer (PC), or other types of workstations or terminal devices. After being properly programmed, a computer with a user interface may be used as a server. It may be considered that those skilled in the art may also be familiar with such structures, programs, or general operations of this type of computer device. Thus, additional explanations are not described for the figures.

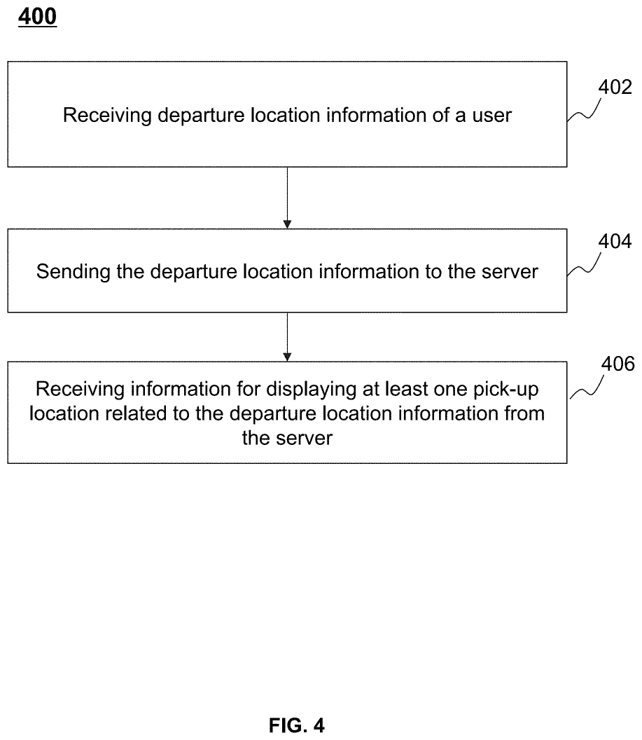

FIG. 4 is a flow chart illustrating an exemplary process for recommending a pick-up location according to some embodiments of the present disclosure. Specifically, the process 400 may be implemented on the user terminal 130 as illustrated in FIG. 1.

In 402, departure location information of a user may be received. The departure location information may include a departure location name and/or positioning information. In some embodiments, the user may input the departure location information through the user terminal 130. For example, the user may enter the departure location information by means of text, image and/or voice. The name of the departure location may be input by the user. In some embodiments, the user terminal 130 may acquire a current location of the user using a positioning technology, and determine the departure location information according to the current location of the user. In some embodiments, the current location of the user acquired by the positioning technology may include latitude and longitude information. The departure location name may be determined according to the latitude and longitude information.

In 404, the departure location information may be sent to the server. In some embodiments, the user terminal 130 may send the departure location information to the server through the network 120.

In 406, information for displaying one or more pick-up locations related to the departure location information may be received from the server. The one or more pick-up locations associated with the departure location information may include one or more recommended pick-up locations, and the one or more recommended pick-up locations may be marked for prompting the user to select the one or more recommended pick-up locations. The user terminal 130 may receive the one or more pick-up locations determined by the server 110, and display the one or more pick-up locations to the user through the display (e.g., display unit 320). In some embodiments, the one or more pick-up locations displayed on the user terminal 130 may include a name, a detailed address, a distance to the user, or the like, or any combination thereof.

The one or more pick-up locations may include one or more recommended pick-up locations. The recommended pick-up locations may be marked so as to facilitate the user's selection, thereby increasing probability that the user selects the one or more recommended pick-up locations. In some embodiments, the one or more recommended pick-up location may have text markings. For example, a word “recommended” may be placed next to each recommended pick-up location. In some embodiments, the one or more pick-up locations may be displayed in a list on the user terminal 130. The one or more recommended pick-up locations may be displayed on the top of the list, such that the user may identify the recommended pick-up locations easily. In some embodiments, the one or more recommended pick-up locations may be displayed in a particular font and/or color different from other pick-up locations. For example, the font of a recommended pick-up location may be larger and/or bolder than the font of other pick-up locations. In some embodiments, a recommended pick-up location may be displayed in forms of an image. For example, a recommended pick-up location may be displayed by accompanying an image of a landmark at the recommended pick-up location.

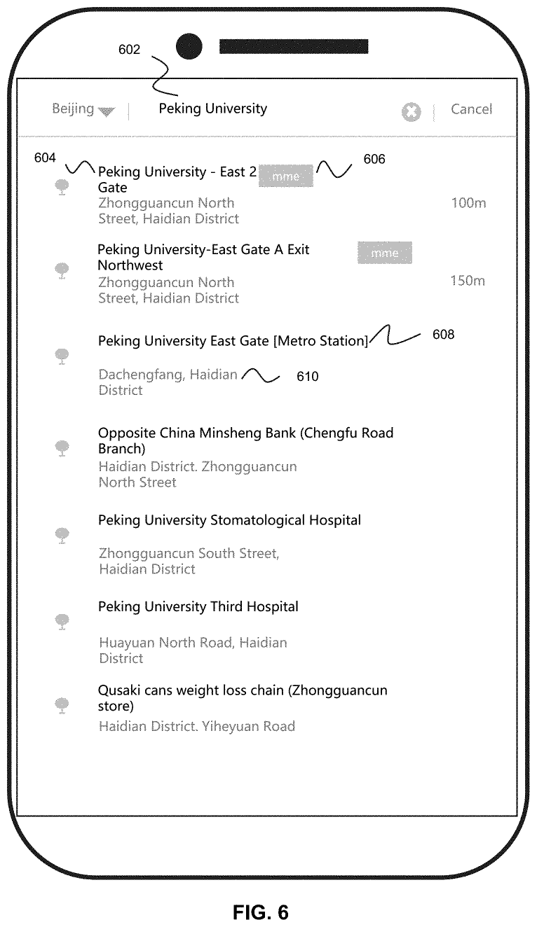

In some embodiments, the user terminal 130 may display the departure location information and the one or more pick-up locations simultaneously. For example, when the user inputs a location name in text, the user terminal 130 may display the location name input by the user and one or more pick-up locations on the same interface in real time. For example, when the user inputs a location name, one or more pick-up locations may be displayed in a same interface so as to facilitate the user's selection. As another example, when the location name and the determined one or more pick-up locations are displayed on the same interface, the user may be aware of errors in his/her input, and modify the incorrect location name in time. More details regarding the displaying and recommending of pick-up locations on the user terminal 130 may be described elsewhere in the present disclosure, For example, FIG. 6 and the descriptions thereof.

In some embodiments, a plurality of recommended pick-up locations may be determined. At least one of the plurality of recommended pick-up locations may be associated with a historical pick-up location in the user's historical orders.

Specifically, the history pick-up location of the user may be determined according to the history order of the user. One of the one or more pick-up locations that is associated with the user's historical pick-up location may be designated as the recommended pick-up location. For example, a recent pick-up location of the user's history pick-up locations may be determined as the recommended pick-up location. In some embodiments, recommended pick-up locations associated with the user's history orders may be marked in a manner different from other recommended pick-up locations. For example, a word “common” may be placed next to a recommended pick-up location associated with the user's history orders, and a word “recommended” may be placed next to other recommended pick-up locations.

In some embodiments, the user may select a pick-up location in the one or more pick-up locations displayed on the user terminal 130. The user may select a recommended pick-up location in the one or more pick-up locations, or select other pick-up locations. After the user's selection of a pick-up location is received, the server 110 may determine a driver who accepts the order, and send the pick-up location selected by the user to the driver so as to prompt the driver to pick up the user at the selected pick-up location on time. In some embodiments, a pedestrian navigation path may be generated and displayed on the user terminal 130 based on the current location of the user and the selected pick-up location. In some embodiments, an estimated walking duration for the user to arrive at the selected pick-up location may be determined according to the current location of the user and the selected pick-up location. In some embodiments, an estimated pick-up duration for the driver to arrive at the selected pick-up location may be determined according to the current location of the driver and the selected pick-up location. In some embodiments, the estimated walking duration of the user may be compared with the estimated pick-up duration of the driver. A departure reminder may be displayed on the user terminal 130 if the estimated walking duration of the user is greater than or equal to the estimated pick-up duration of the driver. The departure reminder may be used to remind the user to go to the selected pick-up location as soon as possible.

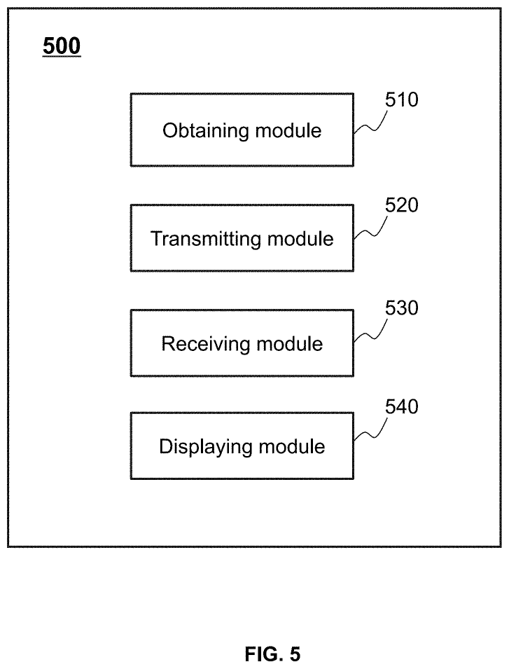

FIG. 5 is a block diagram illustrating a pick-up location recommending apparatus according to some embodiments of the present disclosure. As shown in FIG. 5, the pick-up location recommending apparatus 500 may include an obtaining module 510, a transmitting module 520, a receiving module 530, and a displaying module 540.

The obtaining module 510 may obtain the departure location information of the user. The departure location information may include a location name and/or positioning information of the departure location.

The transmitting module 520 may send the departure location information to the server 110.

The receiving module 530 may receive one or more pick-up locations determined by the server, where the one or more pick-up locations includes one or more recommended pick-up locations.

The displaying module 540 may display the one or more pick-up locations. The one or more recommended pick-up locations may be marked for facilitating the user's selection.

In some embodiments, the pick-up location displayed by the displaying module 540 may include a name, a detailed address, a distance to the user, or the like, or any combination thereof. In some embodiments, the one or more recommended pick-up locations may have a text marking. For example, a word “recommended” may be placed next to a recommended pick-up location.

In some embodiments, the displaying module 540 may display the one or more pick-up locations in a list, and the one or more recommended pick-up locations may be displayed on the top of the list. In some embodiments, a recommended pick-up location may have a particular font and/or color different from other pick-up locations. In some embodiments, the displaying module 540 may display the departure location information and the one or more pick-up locations simultaneously. In some embodiments, the displaying module 540 may display all of the one or more pick-up locations in an interface for the user to select. In some embodiments, the displaying module 540 may display a pedestrian navigation path and/or an estimated walking duration from the current location of the user to a pick-up location selected by the user. In some embodiments, the displaying module 540 may display a departure reminder to remind the user to leave for the selected pick-up location as soon as possible.

In some embodiments, the pick-up location recommendation apparatus 500 may be implemented on any apparatus device for recommending pick-up locations. The apparatus may include at least one processor and at least one memory. The at least one memory may be used for storing computer instructions. The at least one processor may be configured to execute at least a portion of the instructions to implement the pick-up location recommendation process as described in FIG. 4.

In some embodiments, the pick-up location recommendation apparatus 500 may be implemented by a computer readable storage medium storing computer instructions that, when executed by a processor, implement the pick-up location recommendation process as described in FIG. 4.

FIG. 6 is a schematic diagram of a display interface for recommending a pick-up location according to some embodiments of the present disclosure.

As shown in FIG. 6, after the user inputs a departure location name 602 on a display interface, the display interface may display a plurality of pick-up locations related to the departure location name. Specifically, the display interface may display information such as a pick-up location name 608, a detailed address of the pick-up location 610, or the like. As for a recommended pick-up location in the pick-up locations, the display interface may display a marking 606 that guides the user to select the recommended pick-up location as well as display a location name 604 of the recommended pick-up location. For example, when the user inputs “Peking University” in the display interface, the display interface may display a plurality of pick-up locations related to Peking University in real time, and display one or more recommended pick-up locations on top of a list including the pick-up locations. In addition, the recommended pick-up locations may be labeled with “Recommended”, making it easier for identification. The distance from the current location to the pick-up location may also be displayed next to each pick-up location for reference.

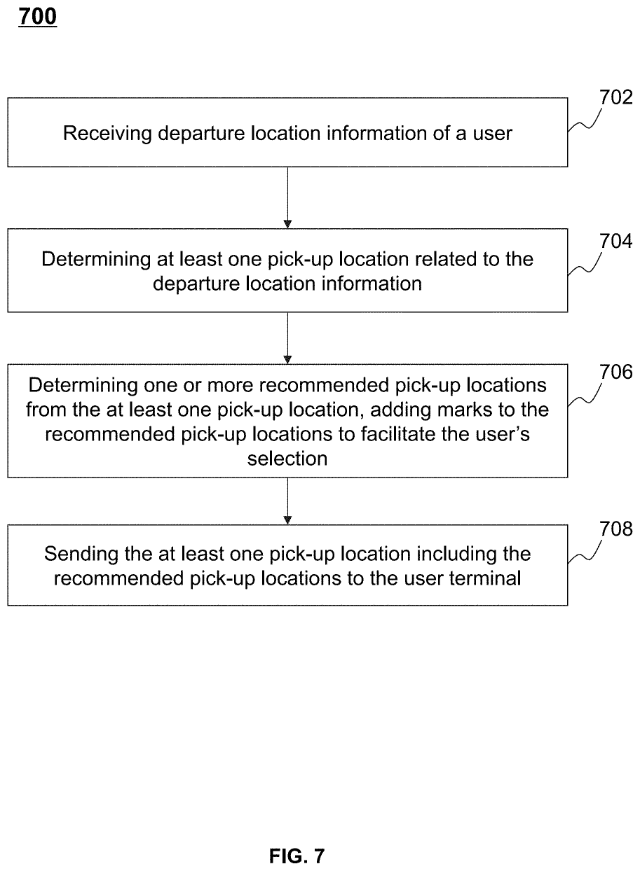

FIG. 7 is a flow chart of an exemplary process for recommending a pick-up location according to some embodiments of the present disclosure. Specifically, the process 700 may be implemented by the server 110 as illustrated in FIG. 1.

In 702, departure location information of a user may be obtained. In some embodiments, the server 110 may obtain the departure location information sent by the user terminal 130 through the network 120. The departure location information may include a location name and/or positioning information of the departure location. The departure location information may be textual information input by the user and/or obtained using a positioning technology.

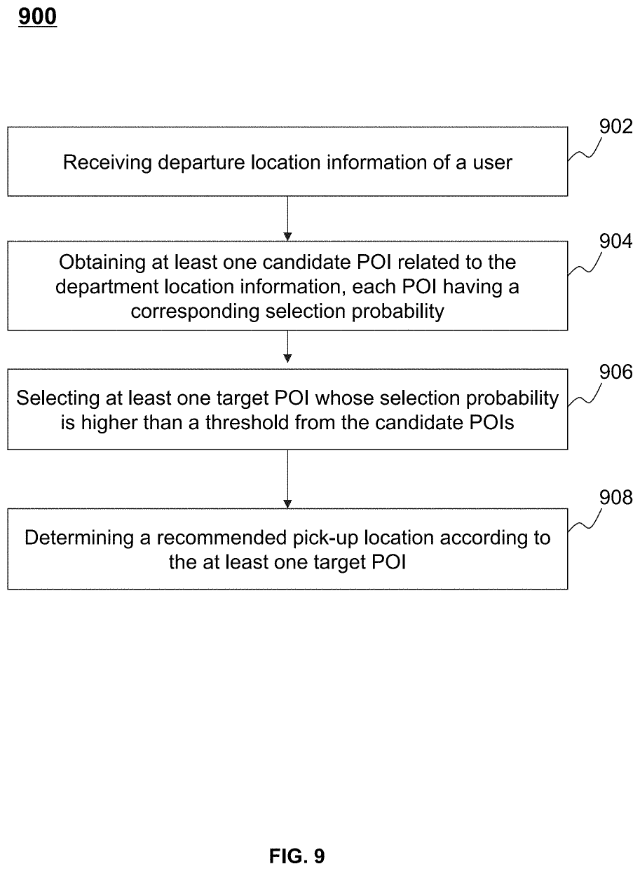

In 704, one or more pick-up locations related to the departure location information may be determined. In some embodiments, candidate points of interest (POIs) related to the departure location information may be obtained, and the one or more pick-up locations may be determined according to the candidate points of interest. For example, the processor may retrieve the location name entered by the user in a database (e.g., storage device 140), and obtain a POI list. The POI list may include at least one candidate POI, and one or more pick-up locations determined according to the candidate POI. Details regarding the determination of the one or more pick-up locations may be described in FIG. 9 and the descriptions thereof.

In 706, one or more recommended pick-up locations may be determined from the one or more pick-up locations. Markings may be added to the recommended pick-up locations to facilitate the user's selection. In some embodiments, a target POI satisfying a certain condition may be selected from the candidate POIs, and the recommended pick-up location may be determined according to the target POI. Details regarding the determination of the recommended pick-up location may be described in FIG. 9 and the descriptions thereof.

The server 110 may add a marking to a recommended pick-up location to facilitate the user's selection. In some embodiments, the server 110 may add a text marking to the recommended pick-up location. For example, the server 110 may add a word “recommended” to a recommended pick-up location. In some embodiments, the server 110 may control the user terminal 130 to display the one or more pick-up locations in a list, and display the recommended pick-up location on top of the list. In some embodiments, the server 110 may determine a particular font and/or color of the recommended pick-up location different from that of other pick-up locations. In some embodiments, the server 110 may provide an image of a landmark at a recommended pick-up location as a displaying manner of the recommended pick-up location.

In 708, the one or more pick-up locations including the one or more recommended pick-up locations may be sent to the user terminal. In some embodiments, the server 110 may send the one or more pick-up locations and the one or more recommended pick-up locations to the user terminal 130 through the network 120. The server 110 may send information such as a pick-up location name, a detailed address, a page layout, markings, etc., to the user terminal 130.

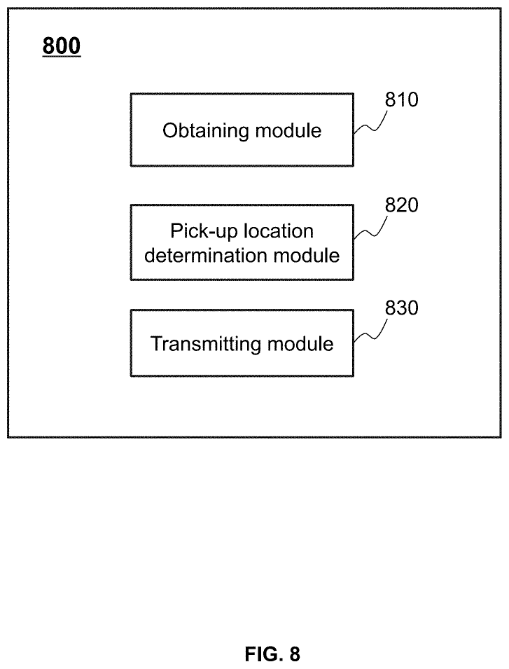

FIG. 8 is a block diagram of an exemplary pick-up location recommendation apparatus according to some embodiments of the present disclosure. As shown in FIG. 8, the pick-up location recommendation apparatus 800 may be implemented by the server 110. The pick-up location recommendation apparatus 800 may include an obtaining module 810, a pick-up location determination module 820, and a transmitting module 830.

The obtaining module 810 may obtain the departure location information of the user. The departure location information may include a location name of the departure location and/or positioning information of the departure location.

The pick-up location determination module 820 may determine one or more pick-up locations associated with the departure location information. In some embodiments, the pick-up location determination module 820 may obtain at least one candidate POI related to the departure location information, and determine the one or more pick-up locations according to the at least one candidate POI.

The pick-up location determination module 820 may also determine one or more recommended pick-up locations from the one or more pick-up locations, and add markings to the one or more recommended pick-up locations for facilitating the user's selection. In some embodiments, the pick-up location determination module 820 may identify a target POI that satisfies a condition in the at least one candidate POI, and determine the recommended pick-up locations according to the target POI. Details regarding the determination of the one or more pick-up locations and the recommended pick-up locations may be described in FIG. 9 and the descriptions thereof.

The transmitting module 830 may send the one or more pick-up locations including the one or more recommended pick-up locations to the user terminal. In some embodiments, the transmitting module 830 may send the one or more pick-up locations including the one or more recommended pick-up locations to the user terminal 130 through the network 120.

In some embodiments, the pick-up location recommendation apparatus 800 may be implemented by any apparatus. The apparatus may include at least one processor and at least one memory. The at least one memory may be used to store computer instructions. The at least one processor may be configured to execute at least a portion of the instructions to implement the process 700.

In some embodiments, the pick-up location recommendation apparatus 800 may be implemented by a computer readable storage medium, which may store computer instructions. The pick-up location recommendation process as described in FIG. 7 may be implemented when the computer instructions are executed by the processor.

FIG. 9 is a flow chart of an exemplary process for determining one or more recommended pick-up locations according to some embodiments of the present disclosure. Specifically, the process 900 for determining the recommended pick-up locations may be implemented by the server 110 as illustrated in FIG. 1.

In 902, departure location information of a user may be received. In some embodiments, the server 110 may obtain the departure location information sent by the user terminal 130 through the network 120. The departure location information may include a location name and/or positioning information of the departure location. The departure location information may be input by the user or obtained using a positioning technology.

In 904, at least one candidate POI related to the departure location information may be obtained. A POI may refer to an information point including a name, a type, and latitude and longitude of a location. The server 110 may obtain a POI list according to the user's departure location information, and the POI list may include at least one POI. The method for obtaining a POI list may be any existing method disclosed in prior art. For example, the server 110 may analyze the location name of the departure location manually input by the user, rewrite, correct, and/or retrieve the analyzed location name, and search related information in a database (for example, storage device 140). After the above retrieval process is complete, the server 110 may obtain at least one POI from the database, and sort the at least one POI so as to obtain the POI list. In some embodiments, the server 110 may calculate a similarity between the location name input by the user and the a plurality of POIs. For example, the server 110 may determine textual similarities of the location name and a plurality of POIs using a text similarity calculation model. The text similarity calculation model may calculate various parameters including a Jaccard similarity coefficient, a cosine similarity, a Manhattan distance, a Euclidean distance, an explicit distance, an edit distance, or the like, or any combination thereof. In some embodiments, the server 110 may determine similarities between the location name and the POIs in other manners, which is not limited in this disclosure. For example, the server 110 may determine similarities between the location name and the plurality of POIs through a semantic model. In some embodiments, the server 110 may determine the POI list based on the similarities between the location name and the POIs. For example, the server 110 may select candidate POIs with similarities being greater than a certain threshold (e.g., 50%, 60%, 80%, etc.) to obtain the POI list. As another example, the server 110 may select a plurality of (e.g., 5, 10, 30, etc.) POIs with higher similarities as the candidate POIs to constitute the POI list.

In some embodiments, the server 110 may determine the candidate POIs by analyzing history order information of a plurality of users to form the POI list. The plurality of users may include the current user and/or other users. Specifically, the server 110 may identify one or more history orders from history orders of a plurality of users that is the same as or similar to the departure location information of the current user. The server 110 may obtain, by analyzing the one or more history orders that is the same as or similar to the departure location information of the current user, a plurality of POIs with higher selection probability (e.g., corresponding to a higher probability that a user may select the POI) in the one or more historical orders that is the same as or similar to the departure location information of the current user. The server 110 may uses the plurality of POIs as candidate POIs.

In 906, at least one target POI whose selection probability is higher than a threshold may be selected from the candidate POIs. The selection probability (also referred to as “click rate”) refers to the probability that a POI is selected by a large number of users in the historical order, which reflects a preference or trends of the large number of users to the POI in the historical order. In some embodiments, each candidate POI in the POI list obtained by the server 110 may have a ranking score. The ranking score may reflect the selection probability of each candidate POI, and the probability that each POI being selected may be determined according to the ranking score. In some embodiments, the selection probability may be determined according to historical orders fulfilled within a period of time. Specifically, a ratio of a total number of times that the user selects a candidate POI to a total order number fulfilled during a time period may be determined as the selection probability of the candidate POI.

The total order number may be the number of orders related to the departure location information. Take “Peking University” as an example of departure location information, a plural of candidate POIs related to “Peking University” may include Peking University, Peking University East Gate [Subway Station], Minsheng Bank (Chengfu Road Sub-branch), Peking University Stomatological Hospital, etc. The server 110 may obtain 1000 orders related to the “departure location” of “Peking University” fulfilled in the last week. If a total number of times that candidate POI “Peking University” being selected in the historical orders is 500, the probability that a user selects the candidate POI “Peking University” may be 0.5. If a total number of times that candidate POI “Peking University East Gate [Subway Station]” being selected in the historical orders is 300, the probability that a user selects the candidate POI “Peking University East Gate [Subway Station]” may be 0.3; If a total number of times that candidate POI “Minsheng Bank (Chengfu Road Branch)” being selected in the historical orders is 150, the probability that a user selects the candidate POI “Minsheng Bank (Chengfu Road Sub-branch)” may be 0.15. If a total number of times that candidate POI “Peking University Stomatological Hospital” being selected in the historical orders is 50, the probability that a user selects the candidate POI “Peking University Stomatological Hospital” may be 0.05.

In some embodiments, a click rate calculation model may be obtained using historical orders fulfilled in a period of time as samples, and the click rate of each candidate POI may be calculated by the click rate calculation model.

In some embodiments, training samples of the click rate calculation model may include a plurality of historical orders fulfilled within a certain period of time. Information of each historical order may include a departure location name input by a user, a corresponding POI list, and a corresponding pick-up location selected by a user. In some embodiments, the click rate of each of the candidate POIs may relate to a POI list corresponding to the each of the candidate POIs. It may be understood that the trained click rate calculation model may take a POI list obtained according to the departure location information input by the user as input, and output the click rate of each candidate POI in the POI list.

For example, features including a location name entered by a user, options of POIs provided to the user, a POI actually selected by a user may be extracted from history orders. An initial model may be trained with the extracted features to obtain the click rate calculation model. The threshold may be determined manually or automatically. In some embodiments, the threshold may be determined via experiments. The threshold may be, for example, 80%, 70%, 60%, 50%, 40%, etc.

In some embodiments, the server 110 may determine top N candidate POIs in the POI list (i.e., with higher probabilities of being selected), where N is an integer greater than or equal to 1. The server 110 may further determine, from the N candidate POIs, a POI with selection probability higher than the threshold as the target POI. N may be, for example, 5, 4, 3, 2, 1, or the like. For example, when N is 3, the server 110 needs to determine the target POI whose selection probability is higher than the threshold from the top three candidate POIs.

In 908, one or more recommended pick-up locations may be determined according to the at least one target POI. The method for determining the one or more recommended pick-up locations according to known POIs may be disclosed in the prior art, which may not be described herein. For example, a popular pick-up location within a certain range may be found as a recommended pick-up location according to the latitude and longitude of a target POI. As another example, a recommended pick-up location may be determined based on historical orders of the user. Specifically, actual pick-up locations in the history orders of the user may be extracted. A pick-up location associated with the target POI (e.g., near the target POI) that has been selected in the user's history orders may be determined as a recommended pick-up location. In some embodiments, for each target POI, the server 110 may determine M recommended pick-up locations, and M may be an integer greater than or equal to 1. For example, M may be 4, 3, 2, 1, etc.

It should be noted that the above description of the process 900 for determining recommended pick-up locations is merely for convenience of description, and the present disclosure is not limited to the scope of the embodiments. It will be understood that, for those skilled in the art, after understanding the principle of the method, any step may be combined arbitrarily without departing from the principle, or any step may be added or deleted. For example, the server 110 may determine candidate POIs that is not greater than the threshold as other pick-up locations, and generate a pick-up location list including the determined other pick-up locations and the recommended pick-up locations. As another example, in 906, top candidate POIs in the POI list may be determined as target POIs without determining whether the selection probabilities of the candidate POIs are greater than the threshold.

Merely for illustration purposes, the method for determining the recommended pick-up location will be described below in a specific example. For better understanding, some of the content will be described in combination with FIG. 6. After a user inputs “Peking University” in a departure location search box on an interface of the user terminal 130, the user terminal 130 may send the departure location information including “Peking University” to the server 110. The server 110 may search “Peking University” in the database, and obtain a plurality of candidate POIs related to “Peking University.” These candidate POIs may include, for example, Peking University, Peking University East Gate [Subway Station], Minsheng Bank (Chengfu Road Sub-branch), Peking University Stomatological Hospital, etc. The server 110 may obtain a selection probability of each of the candidate POIs according to data of history orders, and sort the candidate POIs according to the selection probability in a descending order. Top three candidate POIs may be Peking University, Peking University East Gate [Subway Station], Minsheng Bank (Chengfu Road Branch). Then the server 110 may determine whether the selection probabilities of the three POIs are greater than a threshold (e.g., 70%). After the server 110 determines that only the selection probability of candidate POI Peking University is greater than the threshold, the candidate POI Peking University may be determined as the target POI. The server 110 may identify multiple recommended pick-up locations nearby according to the latitude and longitude of the target POI Peking University, and select two recommended pick-up locations including Peking University-East Second Gate and Peking University-East Gate A Exit Northwest, and designate the two recommended pick-up locations as ultimate result of recommended pick-up locations. In addition, the server 110 may determine the candidate POIs whose selection probabilities are not greater than the threshold as other pick-up locations. The recommended pick-up locations and the other pick-up locations may constitute the pick-up location list. In some embodiments, the number of pick-up locations in the pick-up location list may not exceed 20.

Beneficial effects that the embodiments of the present disclosure may bring about may include, but are not limited to: (1) providing a user with pick-up locations for selection, and adding special markings to recommended pick-up locations to facilitate the user's selection; (2) avoiding selection of unreasonable pick-up locations by guiding the user to select the recommended pick-up locations; (3) improving user experiences of passengers; (4) improving efficiency of drivers as well as increasing long-term benefits of drivers; (5) improving overall income of car-hailing platform. It should be noted that different embodiments may have different beneficial effects. In different embodiments, the beneficial effects may be any combination of one or more beneficial effects mentioned above, or any other beneficial effects that may be reached.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “module,” “unit,” “component,” “device,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claim subject matter lie in less than all features of a single foregoing disclosed embodiment.

1. An apparatus for recommending a pick-up location, comprising:
at least one storage medium including a set of instructions that recommend a pick-up location; and
at least one processor configured to communicate with the at least one storage medium, wherein when executing the set of instructions, the at least one processor is directed to:
obtain departure location information of a first user, where the departure location information of the first user includes at least one of a name of a departure location or positioning information of the departure location;
receive one or more recommended pick-up locations associated with the departure location information based at least on the departure location information; and
display the one or more recommended pick-up locations with markings.

2. The apparatus of claim 1, wherein to receive one or more recommended pick-up locations associated with the departure location information based at least on the departure location information, the at least one processor is directed to:
send the departure location information to a server; and
receive the one or more recommended pick-up locations determined by the server based on the departure location information.

3. The apparatus of claim 2, wherein to receive the one or more recommended pick-up locations determined by the server based on the departure location information, the at least one processor is directed to:
receive information for displaying one or more pick-up locations related to the departure location information from the server, wherein the one or more pick-up locations include the one or more recommended pick-up locations.

4. The apparatus of claim 1, wherein the markings include text markings and to display the one or more recommended pick-up locations with the markings, the at least one processor is directed to:
place the text markings next to the one or more recommended pick-up locations.

5. The apparatus of claim 3, wherein to display the one or more pick-up locations, the at least one processor is directed to:
display the one or more pick-up locations in a list, wherein the one or more recommended pick-up locations are displayed on top of the list.

6-7. (canceled)

8. The apparatus of claim 1, wherein the processor is further directed to:
obtain a pick-up location selected by the first user; and
send the selected pick-up location to a user terminal of a second user.

9. The apparatus of claim 8, wherein the processor is further directed to:
determine a pedestrian navigation path according to a current location of the first user and the selected pick-up location; and
display the pedestrian navigation path on a user terminal of the first user.

10-28. (canceled)

29. An apparatus for recommending a pick-up location, comprising:
at least one storage medium including a set of instructions that recommend a pick-up location; and
at least one processor configured to communicate with the at least one storage medium, wherein when executing the set of instructions, the at least one processor is directed to:
obtain departure location information of a first user, where the departure location information of the first user includes at least one of a name of a departure location or positioning information of the departure location;
determine one or more recommended pick-up locations associated with the departure location information based at least on the departure location information; and
send the one or more recommended pick-up locations related to the departure location information to a user terminal of the first user.

30. The apparatus of claim 29, wherein to determine one or more recommended pick-up locations associated with the departure location information based at least on the departure location information, the at least one processor is directed to:
determine one or more pick-up locations related to the departure location information based at least on the departure location information; and
determine the one or more recommended pick-up locations related to the departure location information based on the one or more pick-up locations.

31. The apparatus of claim 29, wherein the at least one processor is further directed to:
determine markings for facilitating selection of the one or more recommended pick-up locations related to the departure location information; and
send the markings with the one or more recommended pick-up locations to the user terminal of the first user.

32. The apparatus of claim 31, wherein the markings comprise:
a text marking for each recommended pick-up location.

33. The apparatus of claim 31, wherein the at least one processor is further directed to:
obtain at least one candidate point of interest (POI) related to the departure location information, each POI having a corresponding selection probability;
determine the one or more pick-up locations related to the departure location information according to the at least one candidate POI;
determine at least one target POI in the at least one candidate POI with a selection probability higher than a threshold; and
determine the one or more recommended pick-up locations according to the at least one target POI.

34. The apparatus of claim 33, wherein to determine the at least one target POI in the at least one candidate POI with a selection probability higher than a threshold, the at least one processor is directed to:
determine top N candidate POIs with higher selection probability in the at least one candidate POI, where N is an integer greater than or equal to 1; and
designate candidate POIs of the top N candidate POIs with selection probabilities greater than the threshold as the at least one target POI.

35. The apparatus of claim 29, wherein the processor is further directed to:
determine the one or more recommended pick-up locations according to pick-up locations in history orders of the first user.

36. The apparatus of claim 29, wherein the processor is further directed to:
obtain a pick-up location selected by the first user; and
send the selected pick-up location to a user terminal of a second user.

37. The apparatus of claim 36, wherein the processor is further configured to:
determine a pedestrian navigation path according to a current location of the first user and the selected pick-up location; and
display the pedestrian navigation path on a user terminal of the first user.

38. The apparatus of claim 36, wherein the processor is further directed to:
determine an estimated walking duration of the first user according to a current location of the first user and the selected pick-up location.

39. The apparatus of claim 38, wherein the processor further directed to:
determine an estimated pick-up duration of the second user according to a current location of the second user and the selected pick-up location.

40. The apparatus of claim 39, wherein the processor is further directed to:
compare an estimated walking duration of the first user with the estimated pick-up duration of the second user; and
send a reminder to the first user if the estimated walking duration of the first user is greater than or equal to the estimated pick-up duration of the second user.

41. A method implemented on a computing device having at least one processor and at least one computer-readable storage medium for recommending a pick-up location, the method comprising:
obtaining departure location information of a first user, where the departure location information of the first user includes at least one of a name of a departure location or positioning information of the departure location;
determining one or more recommended pick-up locations associated with the departure location information based at least on the departure location information; and
sending the one or more recommended pick-up locations related to the departure location information to a user terminal of the first user.

42-54. (canceled)
